(19) United States
(12) Patent Application Publication
(10) Pub. No.: US 2015/0220987 A1
(43) Pub. Date: Aug. 6, 2015

(54) Method which uses: keywords or keywords combined with a sounds-like algorithm, geographic coordinates, and proximity, in order to match client service requests with service providers

(71) Applicant: Antonio Alberto Ugando, JR., Miramar, FL (US)

(72) Inventor: Antonio Alberto Ugando, JR., Miramar, FL (US)

(21) Appl. No.: 14/596,211

(22) Filed: Jan. 13, 2015

Related U.S. Application Data
(60) Provisional application No. 61/935,272, filed on Feb. 3, 2014.

(51) Int. Cl. G06Q 30/02; G06F 17/30

(52) U.S. Cl. CPC G06Q 30/0256; G06F 17/30699; G06Q 30/0261; G06Q 30/0269

(57) ABSTRACT

In general, the following invention consists of a method which uses: keywords or keywords combined with a sounds-like algorithm, geographic coordinates, and proximity, in order to match client service requests with service providers. Keywords which are found within the description of the service request, which is provided by a client, are used to match relevant service providers. Additional relevancy is achieved by using the geographic coordinates of both client and provider, and determining their proximity. Service providers who operate within a certain proximity of a client, are relevant to the client, and vice versa.

### FIELD OF THE INVENTION

This invention relates to the technical field of matching client service requests with service providers.

### BACKGROUND OF THE INVENTION

Clients who need to have a service completed for them, such as: roof repair, lawn maintenance, plumbing, paint job, A/C repair, etc., tend to perform searches via the internet, in order to find a service provider who can perform the job. Clients also use word-of-mouth, in which they ask friends if they could recommend a service provider for a particular service. Clients also refer to advertisements, in order to contact a service provider to obtain a particular service.

From a client's point of view, searching for a service provider can be very time consuming and frustrating. Client's need to ask around, make phone calls, perform searches on the internet, etc., in order to find a service provider. In certain instances, such as when a client refers to a physical advertisement in order to reach out to a service provider, there is no means of evaluating the service provider's previous track record, thus the client could potential make a blind decision when choosing a service provider. In addition, while searching for a service provider, a client needs to keep a tally of what each individual service provider charges for their service, and compare this against a service provider's verbal or quantitative track record, in order to come to a final decision.

Service providers, who rely on clients for their business, currently pay to have their services advertised via multiple means of communication, be it: the internet, television, radio, physical media, etc. These service providers are practically paying to promote their business to any potential client who may be viewing their advertisement. There is no guarantee for the service provider, that the person who is viewing this advertisement is a potential client. Also, it is up to the client to reach out to the service provider in order to request the service. There is no means for the service provider to make an offer to the client, for the service which is being requested. In addition, the service provider has no clue of who he/she is doing business with; there is no means of evaluating the client's previous track record (e.g. Has the client fulfilled his/her obligations in prior business transactions?).

### SUMMARY OF THE INVENTION

The main objective of this invention is to create a new and efficient means of handling service requests from both a client and service provider's point of view.

The present invention allows a client to submit a service request, to take place at a certain location, via a system. Service providers are able to filter these service requests within the system, and in turn view service requests which pertain to their line of business. In addition, service providers can also be notified when new service requests, which meet their filter criteria, become available in the system. Service providers have the opportunity to submit offers on service requests, and they can also be notified when other competing offers are submitted on these service requests. Prior to placing an offer, service providers can view a client's rating, in order to evaluate the client's previous track record in previous business transactions. Service providers can also post messages related to the current offer, for the client to read. Clients can also post messages related to the current offer, for the service provider to read. Clients can be notified when new offers are placed on their service requests, and they can view each service provider's rating, in order to evaluate the service provider's previous track record. In addition, if the client has received multiple offers, the best possible service provider is recommended to the client. This is done using an algorithm which takes the service provider's offer amount and rating into consideration. Once a client accepts an offer, they can call the service provider in order to make arrangements to have the service completed. The client can also rate a service provider once an offer is accepted, and a service provider can also rate a client at this point.

### BRIEF DESCRIPTION OF THE DRAWINGS

FIG. 1 depicts the view which is used to capture the service that is being requested by the client. It contains a description of what is being requested, a deadline for the request, a location of where the service will take place, and any media which could be used in aiding a service provider in determining an offer.

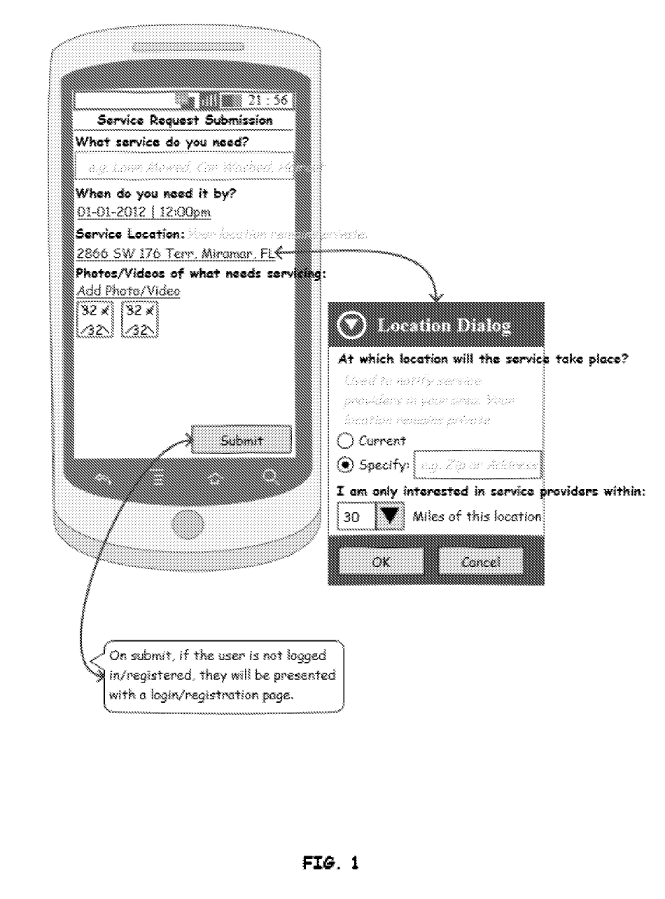

FIG. 2 depicts the view which by default displays all of the service requests that are within a certain proximity to the user, or those that fall within the filter which is defined. From this view, a user also has the ability to view service requests and offers which they have submitted.

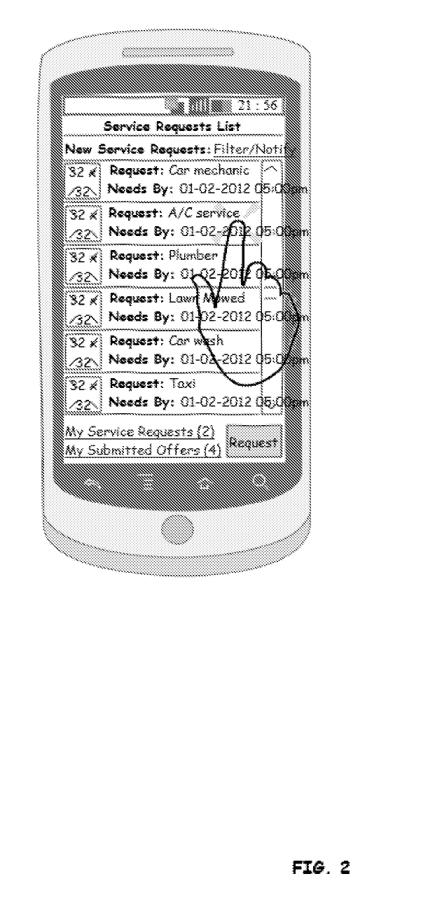

FIG. 3 depicts the view which is used to filter service requests by locations and keywords or keywords and sounds-like. It can also be used to configure notifications that arise from the application.

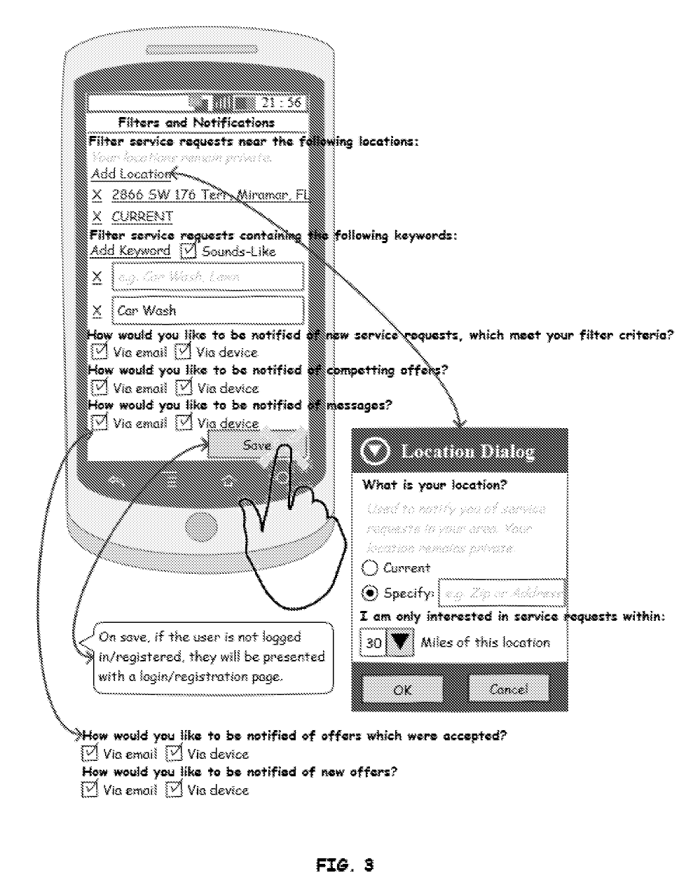

FIG. 4 depicts the view which describes information about the service request, such as: the service which is requested, the deadline for the service, the client's rating, any media depicting what needs service, any competing offers, and a countdown to the deadline. Service providers are able to submit an offer from this view.

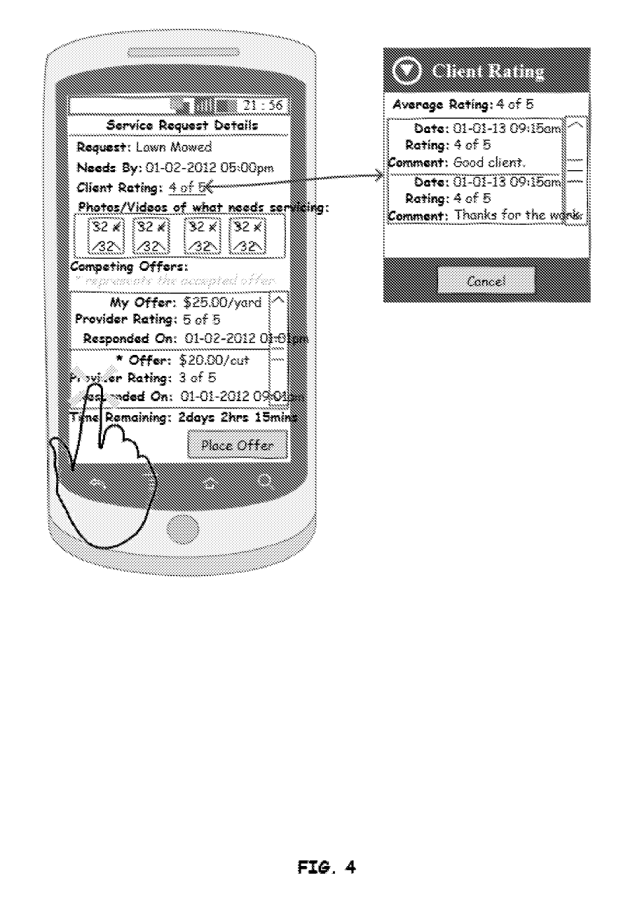

FIG. 5 depicts the view which is used to submit an offer for a service request. It contains an offer amount, a unit for the offer, the service provider's phone number, and a message.

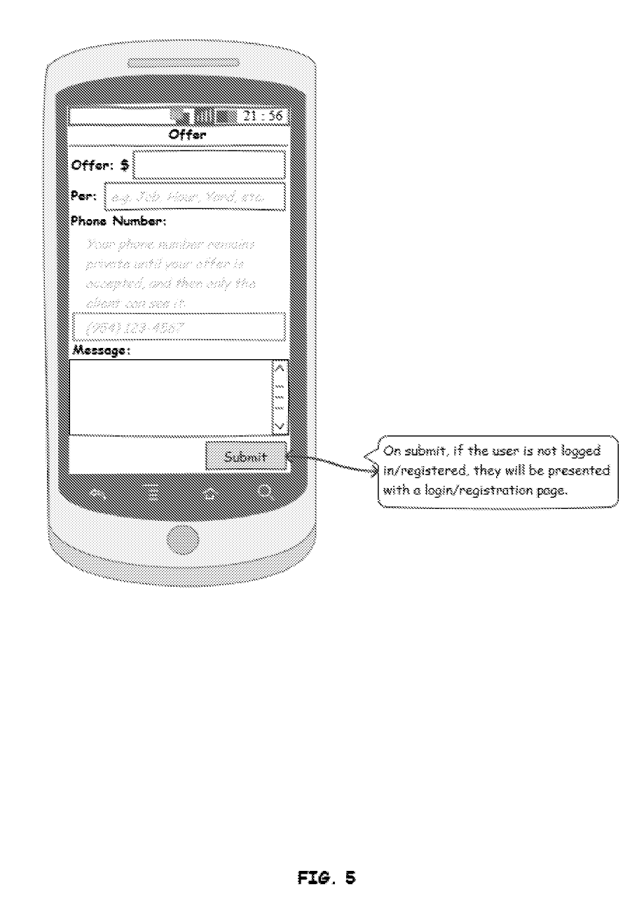

FIG. 6 depicts the view which lists the service requests that a particular client has submitted. It contains a description of what is being requested, a deadline for the request, a location of where the service will take place, the client's average rating, any media which could be used in aiding a service provider in determining an offer, and any offers which were received for the current service request.

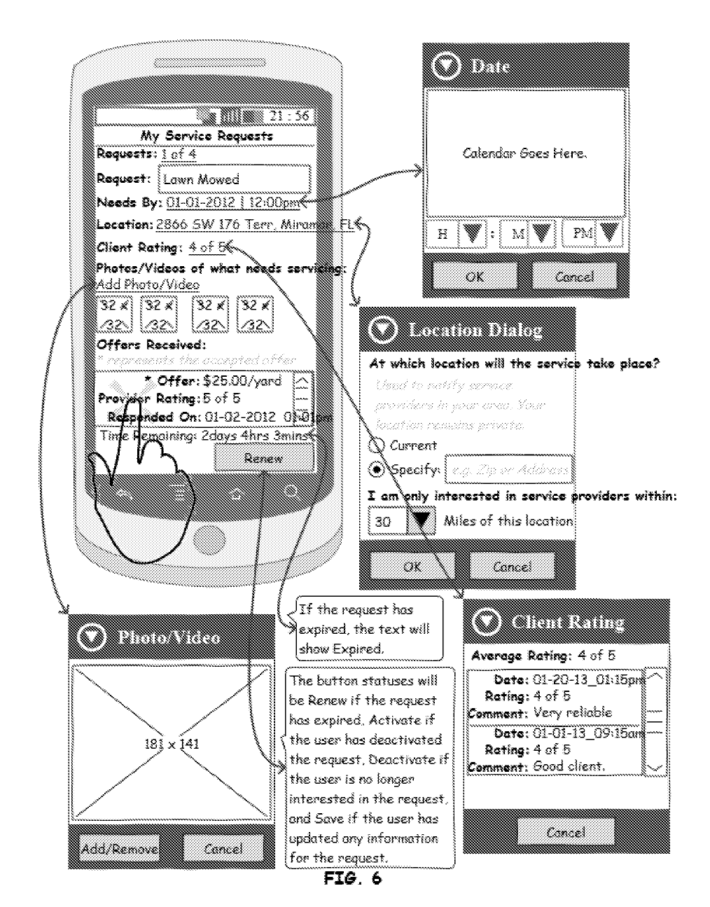

FIG. 7 depicts the view which describes the details of an offer which was placed by a service provider. It contains the offer amount and unit, the provider's average rating, the ability to rate a provider, date on which the offer was placed, and a list of all messages which pertain to the offer.

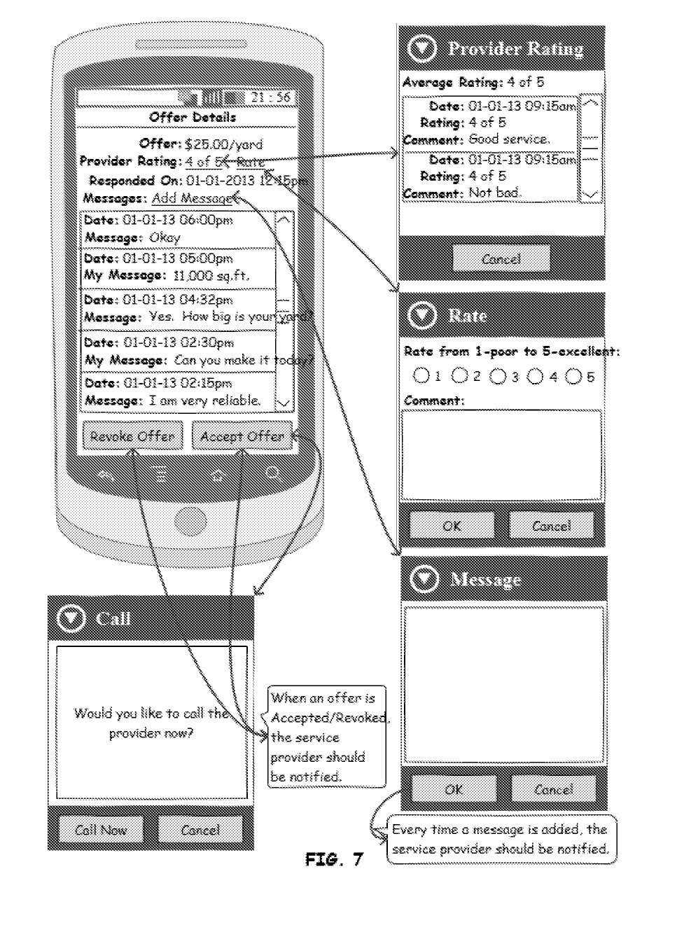

FIG. 8 depicts the view which lists all of the offers which have been submitted by a service provider.

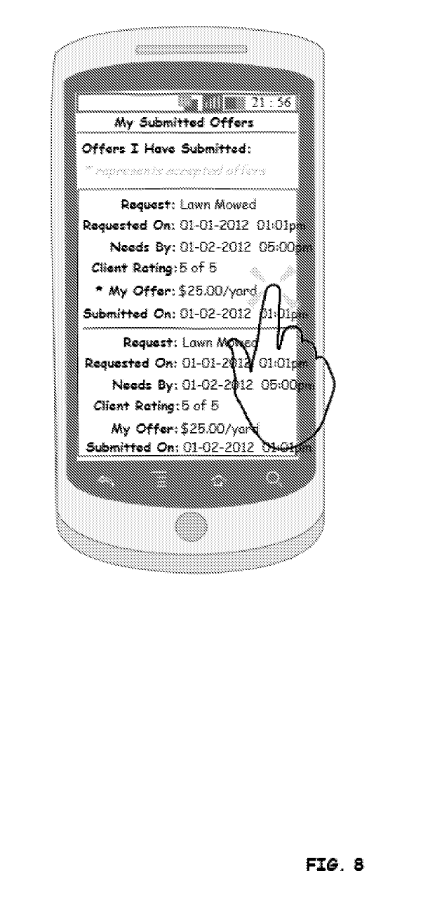

FIG. 9 depicts the view which is used by a service provider in order to make changes to an offer which he/she has submitted. It contains a description of the request, date on which the request was submitted, deadline for the request, the client's average rating, the ability to rate a client, the offer amount and unit, a list of all messages which pertain to the offer, and a list of competing offers.

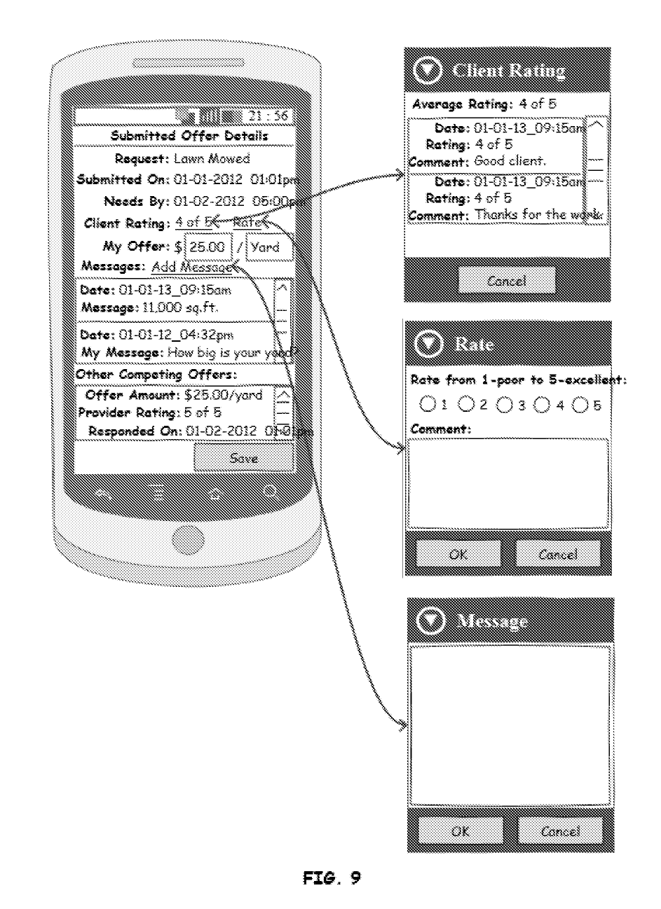

### DETAILED DESCRIPTION OF THE INVENTION

A client submits a service request via a system by providing a description of the service which they need. The client also provides a deadline date for the request, which can later be used when sorting relevant requests ascended by this date. The deadline for the request is also used to automatically make requests inactive after the deadline is reached. This mechanism allows non-active requests to automatically “fall off the charts”, and thus not displace relevant results. The deadline for the request is also used to display a countdown from the current date to the deadline. In addition to the description and deadline, the client also provides geographic coordinates: either implicitly via the client's system (e.g. GPS radio, browser geo location API), or explicitly via manual input (e.g. address, zip) which is then geocoded in order to obtain the geographic coordinates. These geographic coordinates provide a means to determine the proximity between a client's location of service and a provider's location of doing business. In addition to the description and geographic coordinates, the client also provides a max distance or radius, which allows the client to make their service request only visible to service providers with geo locations that fall within the area of this max radius. A client is also able to provide media content, which could be used in aiding a service provider in determining an offer, and in identify what needs servicing. If a client submits a service request, which matches the filter criteria of a service provider, and the service provider has requested to be notified, then a notification about the new service request will be sent out to the service provider.

By default, service requests are sorted by most recently created, but can also be sorted by the deadline date. If no location based filter criteria are entered, then the service provider's current geographic coordinates are obtained implicitly via their system (e.g. GPS radio, browser geo location API), or explicitly via manual input (e.g. address, zip) which is then geocoded in order to obtain the geographic coordinates. These geographic coordinates are then used to retrieve service requests with geo locations which are found within a max predetermined distance or radius. Service providers have the ability to create filter criteria from this view. Any filter criteria which a service provider enters will directly affect the service requests which are displayed. If provided by the client, for each service request, a default media component is displayed along with the description of the request, and the deadline date. If a service request is selected, a complete detail of the request will be displayed. Clients have the ability to create service requests from this view, and they can also see prior service requests which they have submitted. Also from this view, service providers have the ability to see prior offers which they have submitted.

A service provider filters service requests by defining keywords that are found within the description of service requests which were provided by clients. The service provider can also apply a sounds-like algorithm to these keywords, which allows for filtering by the phonetic sound of keywords. In addition to the keywords and sounds-like algorithm, the service provider is also able to provide multiple geographic coordinates: either implicitly via the service provider's system (e.g. GPS radio, browser geo location API), or explicitly via manual input (e.g. address, zip) which is then geocoded in order to obtain the geographic coordinates. These multiple geographic coordinates provide a means to determine the proximity between a provider's locations of doing business and a client's location of service (e.g. a service provider may provide service throughout multiple geo locations). In addition to the keywords, sounds-like algorithm, and multiple geographic coordinates, the provider also provides a max distance or radius per geo location, which allows the provider to filter service requests with geo locations that fall within the area of this max radius. When a service provider filters service requests, they can choose to be notified when any new service requests, which meet their filter criteria, become available. This notification may occur either via an external source, such as email, or via the device or system on which the selection for notification was made. Using this same mechanism, notifications can also be sent for: competing offers, accepted offers, and in the case of both clients and providers; messages, and in the case of clients; new offers.

The details of a service request can greatly assist a service provider in deciding if they should or should not submit an offer, and if so, for how much. These details include a description of the service which is being requested, a deadline, the client's average rating along with comments, any media depicting what needs service, and a countdown from the current date to the deadline. It also includes any competing offers which may have been submitted by service providers for the service request. The data which is shown for each competing offer consists of an offer amount/unit, the service provider's average rating, and the date on which the offer was placed. This date is used to sort the competing offers by most recent. An offer which was accepted, or an offer which was already made by the service provider who is viewing the details, are both flagged. A service provider has the opportunity to submit an offer for a service request, though they are prevented from submitting multiple offers for the same service request, although they do have the opportunity to edit an existing offer.

A service provider submits an offer by providing an offer amount, a unit (if applicable, for this amount), their phone number, and a message (if applicable). Their phone number remains private until their offer is accepted, and then only the client can see it. If an offer is submitted on a service request, and the client has requested to be notified, then a notification about the offer will be sent out to the client.

A client has the ability to view previously submitted service requests, and make modifications to these requests. They can easily switch between service requests, which would bring up all of the details that pertain to that request. A client can update the service request's description, deadline, location, and media by adding or removing media content as needed. They can renew a service request if the deadline has passed, deactivate or activate a request, and save changes to a request. A countdown from the current date to the deadline is shown, which can help a client determine the exact time remaining till the deadline is reached. A client can also view their average rating, and comments which were left by service providers whom they have done business with in the past. Any competing offers which may have been submitted by service providers for the service request are also shown. The data which is shown for each competing offer consists of an offer amount/unit, the service provider's average rating, and the date on which the offer was placed. This date is used to sort the competing offers by most recent. An offer which was accepted is flagged. If a competing offer is selected, a complete detail of the offer will be displayed. If a client updates a service request, and it matches the filter criteria of a service provider, and the service provider has requested to be notified, then a notification about the updated service request will be sent out to the service provider, but only if the service provider has not been notified of this service request.

The details of an offer can be used by a client, to decide whether they want to accept the offer. These details consist of the offer amount/unit, service provider's average rating with comments, and the date on which the offer was submitted. The client can send messages to the service provider, which are related to this offer, as well as view messages which have been received. The messages contain the date on which they were sent, as well as text representing the message itself. The messages are sorted ascending by most recent. The client can accept the offer at any point, upon which they then will be able to rate the service provider, and the service provider will also be able to rate them. At this point, the client will also be able to call the service provider, at the phone number which the service provider entered, when the offer was made. At any time, a client can also revoke an offer which was accepted. If an offer is accepted, and the service provider has requested to be notified, then a notification about the acceptance will be sent out to the service provider; the same goes if an offer is revoked.

A service provider is able to navigate through all of the offers which they have submitted. Information about the offer is displayed, which can allow the service provider to identify a particular offer. This information includes: a description of the service request, the date on which the request was made, the deadline for the request, the client's average rating, the offer amount/unit, and the date on which the offer was made. Offers which were accepted are flagged. If an offer is selected, the details of the offer will be displayed.

The details of an offer include: the description of the service request, the date on which the request was made, the deadline for the request, the client's average rating with comments, and the offer amount/unit which are modifiable. The service provider can save changes made to the offer amount/unit at any time. The service provider can send messages to the client, which are related to this offer, as well as view messages which have been received. The messages contain the date on which they were sent, as well as a text representing the message itself. The messages are sorted ascending by most recent. If the client has accepted the service provider's offer, then the service provider can also rate the client. The detail also includes any competing offers which may have been submitted by other service providers for the service request. The data which is shown for each competing offer consists of an offer amount/unit, the service provider's average rating, and the date on which the offer was placed. This date is used to sort the competing offers by most recent.

1. A method which uses: keywords or keywords combined with a sounds-like algorithm, geographic coordinates, and proximity, in order to match client service requests with service providers, the method comprising the steps of:
a. Capturing a client's service request, this consists of a description of the service, deadline to complete the service, a location of where the service will take place, max distance or radius to service providers, and media content.
b. Displaying a list of service requests which are either filtered using predetermined criteria which were set by a service provider, or if no criteria were set, using the service provider's current geo location to retrieve service requests with geo locations which are found within the proximity of the service provider.
c. Providing a means of filtering service requests by combining: keywords, keywords with a sounds-like algorithm, geographic coordinates, and a max distance or radius per geo location.
d. Providing a means for service providers to receive notifications, when any new service requests, which meet their filter criteria, become available.
e. Providing a means for clients to receive notifications on new offers and messages which were submitted by service providers.

2. The method of claim 1 wherein the deadline date can later be used when sorting relevant requests ascended by this date.

3. The method of claim 1 wherein the deadline for the request is used to automatically make requests inactive after the deadline is reached, allowing non-active requests to automatically “fall off the charts”, and thus not displace relevant results.

4. The method of claim 1 wherein the deadline for the request is used to display a countdown from the current date to the deadline.

5. The method of claim 1 wherein the location of service is obtained either implicitly via the client's system, or explicitly via manual input and then geocoded in order to obtain the geographic coordinates.

6. The method of claim 1 wherein the max distance or radius which is set per service request, is used to make the service request only visible to service providers with geo locations that fall within the area of this max radius.

7. The method of claim 1 wherein the media content can be used in aiding a service provider in determining an offer, and in identify what needs servicing.

8. The method of claim 1 wherein the service provider filters service requests by defining keywords that are found within the description of service requests which were provided by clients.

9. The method of claim 1 wherein the service provider filters service requests by defining keywords that are found within the description of service requests which were provided by clients, and applying a sounds-like algorithm to these keywords, which allows for filtering by the phonetic sound of keywords.

10. The method of claim 1 wherein the service provider provides multiple geographic coordinates: either implicitly via a system or explicitly via manual input, which is then geocoded in order to obtain the geographic coordinates, which are then used to determine the proximity between a provider's locations of doing business and a client's location of service.

11. The method of claim 1 wherein the provider provides a max distance or radius per geo location, which allows the provider to filter service requests with geo locations that fall within the area of this max radius.

12. The method of claim 1 wherein the client submits a service request, which matches the filter criteria of a service provider, and the service provider has requested to be notified, and a notification about the new service request is sent out to the service provider.

13. The method of claim 1 wherein the service provider submits an offer on a service request, and the client has requested to be notified, and a notification about the offer is sent out to the client.

14. Providing a means for service providers to receive notifications on new competing offers, accepted offers, and revoked offers.

15. Providing a means for service providers to receive notifications on messages which were sent by clients.
